(19) United States
(12) Patent Application Publication
(10) Pub. No.: US 2026/0203614 A1
(43) Pub. Date: Jul. 16, 2026

(54) GUIDING AI-BASED RULE SET EXTRACTION BY LOGIC ANALYZER

(71) Applicant: International Business Machines Corporation, Armonk, NY (US)

(72) Inventors: ULRICH MARTIN JUNKER, Antibes (FR); Stephane Hillion, Antibes (FR); Jean-Michel Gerard, Bernard BERNELAS, Nice (FR); THIERRY KORMANN, Valbonne (FR)

(21) Appl. No.: 19/051,523

(22) Filed: Feb. 12, 2025

(30) Foreign Application Priority Data
Jan. 16, 2025 (GB) 2500599.2

(51) Int. Cl. G06N 5/025

(52) U.S. Cl. CPC G06N 5/025

(57) ABSTRACT

Rule set extraction includes extracting, using an artificial intelligence (AI) model, a set of candidate rule sets from a text document and, for individual rules sets of the candidate rule sets, analyzing, using a logic analyzer, an individual rule set, identifying a set of additional rules, and enriching the individual rule set with the set of additional rules to determine an enriched candidate rule set corresponding to the individual rule set. Further, rule set extraction includes prioritizing a set of enriched candidate rule sets of the set of candidate rules sets and, based on the prioritizing, filtering the set of enriched candidate rule sets to determine a set of consolidated rule sets.

### BACKGROUND

The present invention relates generally to rule set extraction. In particular it provides a computer-implemented method, system, computer program product and a computer program for guiding AI-based rule set extraction by logic analyzer.

Many regulatory texts prescribe decisions for given cases. These texts can be formalized in the form of condition-action rules and used by a rule engine, which determines the prescribed decisions for a large volume of cases. The extraction of condition-action rules from regulatory texts has been studied in knowledge acquisition, but continues to be considered a difficult topic.

### SUMMARY

According to some embodiments of the present invention there are provided a computer implemented method, a system, a computer program product, and a computer program according to the independent claims.

One aspect of the present invention provides a computer implemented method for rule extraction, the computer-implemented method comprising: extracting, using an artificial intelligence (AI) model, a set of candidate rule sets from a text document; for each of the candidate rule sets: analyzing, using a logic analyzer, also referred to as a logical rule analyzer, the candidate rule set; identifying a set of additional rules; and enriching the candidate rule set with the set of additional rules to determine a corresponding enriched candidate rule set; prioritizing each of the enriched candidate rule sets; and, based on the prioritizing, filtering the enriched candidate rule sets to determine a set of consolidated rule sets.

Another aspect of the present invention provides a system for rule extraction, the system comprising: a rule set extractor for extracting, using an artificial intelligence (AI) model, a set of candidate rule sets from a text document; and a logic analyzer, for each of the candidate rule sets, for: analyzing, using a logical rule analyzer, the candidate rule set; identifying a set of additional rules; and enriching the candidate rule set with the set of additional rules to determine a corresponding enriched candidate rule set; prioritizing each of the enriched candidate rule sets; and, based on the prioritizing, filtering the enriched candidate rule sets to determine a set of consolidated rule sets.

A further aspect of the present invention provides a computer program product for rule extraction, the computer program product comprising a computer-readable storage medium readable by a processing circuit and storing instructions for execution by the processing circuit for performing computer-implemented methods according to embodiments of the present invention.

Still a further aspect of the present invention provides a computer program stored on a computer-readable medium and loadable into the internal memory of a digital computer, comprising software code portions for performing computer-implemented methods according to embodiments of the present invention, when the program is run on a computer.

Some embodiments of the present invention provide a computer-implemented method, system, computer program product and computer program, further comprising reviewing the set of consolidated rule sets to refine the set of consolidated rule sets with updates to the additional rules to determine a reviewed set of rule sets.

Some embodiments of the present invention provide a computer-implemented method, system, computer program product and computer program, further comprising building a training example from the set of consolidated rule sets and the text document; and based on the training example, fine-tuning the AI model to determine enhanced responses for the text document.

Some embodiments of the present invention provide a computer-implemented method, system, computer program product and computer program, wherein the text document is a regulatory text.

### BRIEF DESCRIPTION OF THE DRAWINGS

The present invention will now be described, by way of example only, with reference to various embodiments of the present invention, as illustrated in the following figures:

FIG. 1 depicts a computing environment 100, according to an embodiment of the present invention;

FIG. 2 depicts operation methods steps for enhancing responses, according to an embodiment of the present invention;

FIG. 3 depicts operation methods steps for rule set extraction, according to an embodiment of the present invention;

FIG. 4 depicts operation methods steps for rule set enhancement, according to an embodiment of the present invention;

FIG. 5 depicts operation methods steps for building training examples, according to an embodiment of the present invention;

FIG. 6 depicts missing rules and arbitration rules, according to an embodiment of the present invention;

FIG. 7 depicts software components according to an embodiment of the present invention; and

FIG. 8 depicts structures, according to an embodiment of the present invention.

### DETAILED DESCRIPTION

Rule set extraction includes extracting, using an artificial intelligence (AI) model, a set of candidate rule sets from a text document and, for individual rules sets of the candidate rule sets, analyzing, using a logic analyzer, an individual rule set, identifying a set of additional rules, and enriching the individual rule set with the set of additional rules to determine an enriched candidate rule set corresponding to the individual rule set. Further, rule set extraction includes prioritizing a set of enriched candidate rule sets of the set of candidate rules sets and, based on the prioritizing, filtering the set of enriched candidate rule sets to determine a set of consolidated rule sets. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

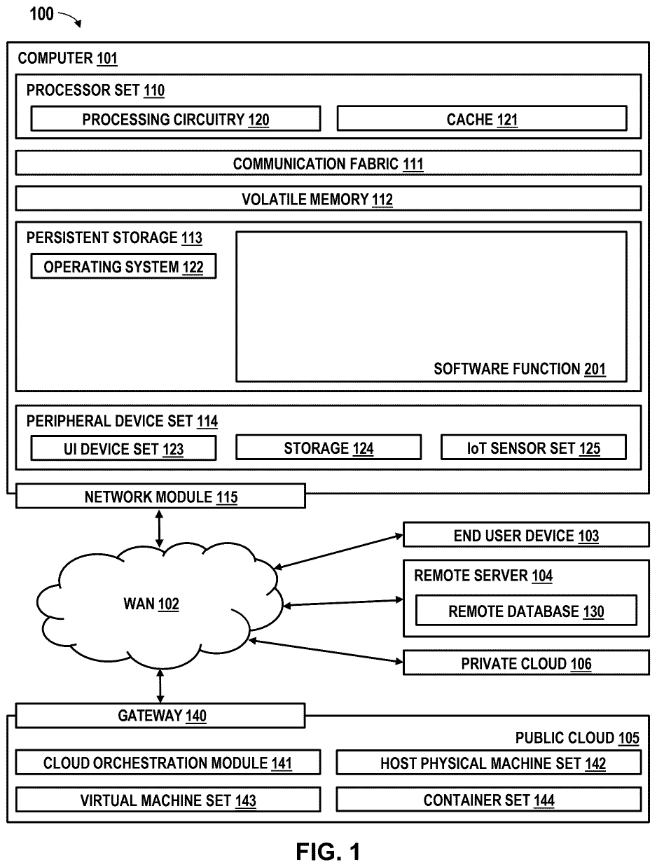

FIG. 1 depicts a computing environment 100. Computing environment 100 contains an example of an environment for the execution of at least some of the computer code involved in performing the inventive computer-implemented methods, such as software functionality 201 for improved rule extraction. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods, for example in the client functionality 1200, and/or the server functionality 1300.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard disk, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that embodiments of the present invention may be practiced with steps in a different order, and/or with hardware elements in configurations that are different than those which are disclosed. Therefore, although the application has been described based upon various embodiments, it would be apparent to those of skill in the art that certain modifications, variations, and alternative constructions would be apparent.

While some embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

Moreover, the same or similar reference numbers are used throughout the drawings to denote the same or similar features, elements, or structures, and thus, a detailed explanation of the same or similar features, elements, or structures will not be repeated for each of the drawings. The terms “about” or “substantially” as used herein with regard to thicknesses, widths, percentages, ranges, etc., are meant to denote being close or approximate to, but not exactly. For example, the term “about” or “substantially” as used herein implies that a small margin of error is present. Further, the terms “vertical” or “vertical direction” or “vertical height” as used herein denote a Z-direction of the Cartesian coordinates shown in the drawings, and the terms “horizontal,” or “horizontal direction,” or “lateral direction” as used herein denote an X-direction and/or Y-direction of the Cartesian coordinates shown in the drawings.

Additionally, the term “illustrative” is used herein to mean “serving as an example, instance or illustration.” Any embodiment or design described herein is intended to be “illustrative” and is not necessarily to be construed as preferred or advantageous over other embodiments or designs.

It is to be understood that although this disclosure includes a detailed description on cloud computing, implementation of the teachings recited herein are not limited to a cloud computing environment. Rather, some embodiments of the present invention are capable of being implemented in conjunction with any other type of computing environment now known or later developed.

For the avoidance of doubt, the term “comprising”, as used herein throughout the description and claims is not to be construed as meaning “consisting only of”.

Generative AI is a type of artificial intelligence that can create original content, such as text, images, audio, video, or code, in response to user prompts or requests. Generative AI uses machine learning models, particularly deep learning networks based on transformer architecture. These models work by identifying and encoding the patterns and relationships in huge amounts of data. One example of generative AI is ChatGPT. Another example is Perplexity, which uses a search engine with generative AI technology.

In general generative AI operates in three phases:
Training, to create a foundation model that can serve as the basis of multiple gen AI applications.
Tuning, to tailor the foundation model to a specific gen AI application.
Generation, evaluation and retuning, to assess the gen AI application's output and continually improve its quality and accuracy.

Data-based generative AI refers to artificial intelligence models that are trained on large datasets to generate new content or data that is similar to the training data. These models learn patterns and structures from the input data, allowing them to create novel outputs across various domains.

Large-language models (LLMs) based on transformer architectures provide new perspectives for rule extraction but have not been fine-tuned for the task due to a lack of massive data sets that associate regulatory texts 802 with rule sets.

There are many LLMs that have been fine-tuned to generate code from text. Whereas they are able to generate code with all control structures, they can also be used to transform parts of regulatory texts involving conditions and actions into code snippets that correspond to if-then statements. These if-then statements are created in isolation and are not combined by a control structure. As such, they have the character of condition-action rules and can be reformulated in a suitable formal rule language. In this way, an LLM can be used to generate rules from text.

It is not sufficient to generate well-formed rules to produce a well-formed rule set. In an ideal rule set, different rules complement each other such that exactly one decision is made for each case. This requirement is easy overlooked. Firstly, there may be cases where no rule in a rule set is applicable. No decision will be made for such a case. Secondly, there may be cases where multiple rules are applicable and those rules are making decisions, which conflict with each other. Hence, rule sets may be incomplete and inconsistent. When generating rule sets, they should be consistent and complete rule sets. If this condition is not met, rule sets with fewer problematic cases may be used in practice.

There is a difference between rule sets and program code even if the rules look similar to if-then statements. The program code arranges the if-then statements in a specific order and, therefore, produces a unique result in all cases: (i) the if-then statements may make decisions by setting the value of a decision variable; (ii) if no if-then statement makes a decision for some case, the result will consist of the initial value of this variable; (iii) if multiple if-then statements make conflicting decisions for another case, their order determines which if-then statement will make the decision. Hence, the ordering of the if-then statements specifies how conflicts are resolved and the initialization of the decision variable ensures that there is a result in all cases. Unlike rule sets, program code therefore is consistent and complete. When generating program code, it is not possible to express a preference with respect to consistency and completeness.

A rule set can be made consistent by fixing an ordering of its rules and it can be made complete by providing a default value. However, this is additional information that might not be present in a regulatory text. A regulatory text may simply specify rules, but need not provide information about the ordering of the rules. Furthermore, it need not provide a default value. An LLM that maps this regulatory text to a program code instead of a rule set therefore might “invent” control information that has not been described in the text. Moreover, this program code might hide errors made by the LLM as far as the conditions of if-then statements are concerned. For example, those conditions might not cover the whole spaces of cases. When using an LLM for extracting rule sets, those errors become visible as missing rules. A similar argument holds for cases with conflicting decisions. As stated above, rule sets having fewer errors can be expressed when extracting rule sets from a regulatory text, but it cannot be expressed when extracting program code.

The problem of generating well-formed rule sets also occurs in rule induction. In rule induction, conflicts between rules may be resolved by computing a priority of a rule based on the examples it covers. Missing cases are handled by a default value, which is specified separately. However, the rule induction algorithms are not enhanced by learning methods that reduce the number of cases with missing and conflicting decisions. As regulatory texts do not include enough examples, methods for priority computation from rule induction cannot be applied when extracting rules from those regulatory texts. If a regulatory text specifies a default value, then it could be used to handle the missing cases in the extracted rule set. However, there may still be errors in the rule set extraction that lead to missing cases, meaning that a method for reducing the number of missing cases will not be made obsolete by such a default value.

The question is how to help rule set extraction methods to reduce the number of cases with missing and conflicting decisions. Reinforcement learning with human feed-back (RLHF) emerged as a promising paradigm for fine-tuning LLMs with additional information. This includes corrections of the responses given to prompts as well as the ranking of different candidate responses. This principle can, of course, be applied to LLMs that extract rules from texts. Such an LLM may generate rule sets that differ in their quality (e.g. the number of rules, the number of cases with missing decisions, the number of cases with conflicting decisions).

Extraction errors are difficult to detect and correct manually. It is very likely that extraction errors lead to rule sets that are inconsistent or incomplete. Incompleteness: there may be cases where none of the extracted rules are applicable, so decision is made in this case. Inconsistency: there may be cases where more than one of the extracted rules are applicable and they make conflicting decisions.

In addition, it is possible that the regulatory text is inconsistent and incomplete. For example, certain legal texts may contain conflicting rules or conflict with other legal texts for particular cases. However, well-defined rule sets should be consistent and complete.

Even if LLMs are used, it is far from evident how to extract condition-action rules from regulatory texts as LLMs have not been fine-tuned to this task due to the lack of massive amounts of data. Even if rule sets are somehow extracted from LLMs, they are likely to contain “hallucinated rules”. Even if rule sets are somehow extracted from LLMs, they are likely to be incomplete and inconsistent. Detecting and correcting cases with missing and conflicting decisions in extracted rule sets is a highly labor-intensive task and will not scale if done manually. Even if cases with missing and conflicting decisions are detected, it is not evident how to use this information for obtaining well-defined rule sets in future queries. Therefore, there is a need in the art to address the aforementioned problem.

An LLM is an example of generative AI, which have shown significant potential for rule extraction and learning tasks. LLMs can be leveraged for rule extraction in various ways. LLMs analyze vast amounts of text data to identify recurring patterns that can be translated into rules. This allows LLMs to extract implicit rules from unstructured data. Once rules are established, LLMs can generate inferences that align with these rules, improving their accuracy in tasks such as question answering and summarization. LLMs can assist in generating initial sets of logic rules for systems. Optionally, these initial sets can then be reviewed and refined, for example, by subject matter experts. LLMs are trained to predict the most probable next word according to training examples. For this purpose, the LLM computes a probability for each candidate word. A sampling procedure then randomly chooses one of the words according to these probabilities. A sequence of words is determined by repeating this procedure several times.

The integration of LLMs into rule extraction processes offers scalability, flexibility, and improved accuracy.

Methodologies for LLM-based rule extraction include:
Hypotheses-to-Theories (HtT) Framework: This two-stage approach uses LLMs to generate and verify rules over training examples, then applies the learned rule library to perform reasoning on test questions; and
RuleFlex Approach: This method uses LLMs as a world model to generate initial sets of logic rules through different prompt engineering techniques, identify variables, and compare rule sets.

Perplexity uses a number of LLMs, such as GPT-4, Claude 3, and Mistral Large.

A prompt in the context of LLMs is a natural language input provided to the model to elicit a desired response or perform a specific task. A prompt is natural language text describing the task that an AI should perform. It can be a query, command, statement, or longer text including context and instructions. Prompts guide the LLM to generate appropriate outputs. They provide the model with the information needed to produce accurate, relevant responses. Prompts can be questions, commands, or context rich statements.

Some logic based generative AI models incorporate logical reasoning capabilities to enhance the performance and reliability of these systems. Researchers are exploring various approaches to combine the strengths of generative models with logical reasoning frameworks. Examples include symbolic AI, which uses logical rules and knowledge representation. Neuro-symbolic AI is an approach that combines neural networks with symbolic AI techniques to create more powerful and flexible artificial intelligence systems. Another example proposes a Bayesian model that includes logical and statistical learning.

Embodiments of the present invention will be described using an LLM as the data based generative AI model. Some embodiments of the present invention can use any LLM that has been trained to generate programming code from text and that permits fine-tuning via additional examples.

Examples of LLMs which have been trained to generate programming code from text include OpenAl Codex, Code Llama (which can generate Python, C++, Java, PHP, TypeScript, C#, and Bash code), StarCoder, CodeT5+, GPT-3, GPT-4, and PaLM 2, GPT-3, GPT-4 and PaLM 2. In some embodiments of the present invention, GPT-4 is used.

Some embodiments of the present invention provide LLM-based rule set extraction by a logic analyzer system comprising:
A rule set extractor which extracts several candidate rule sets from a given regulatory text which is provided by a rule-extraction query.
A rule set enhancer which uses a logic analyzer to consolidate each candidate rule set by bringing it into a complete, consistent, and compact form. The rule set enhancer also computes a score for each of these consolidated candidate rule set based on the analysis results (e.g. the number of missing rules, conflicting rules, and generalized rules). It selects those consolidated candidate rule sets according to a selection rule (e.g. by using a threshold on the score or by choosing the k best). Any of these selected consolidated rule sets may be given as answer to the rule-extraction query.
A review of the selected consolidated rule sets by a domain expert who may refine, validate, and rank these rule sets. The domain expert will choose the decision for the missing rules and the arbitration rules.
A training example builder which produces enhanced responses for the given regulatory text based on the accepted consolidated rule sets.
A fine-tuning algorithm which uses the training examples to finetune.

Some embodiments of the present invention also provide a computer-implemented method to guide a LLM-based rule set extraction by logic analyzer system, by transforming, by a logic analyzer, a set of rules into a general form, to identify missing rules in order to make the rule set complete, and to identify arbitration rules to make the rule set consistent. The logic analyzer gives guarantees about completeness, consistency, and compactness by following basic principles. The logic analyzer is applied to rule sets generated by the rule set extractor.

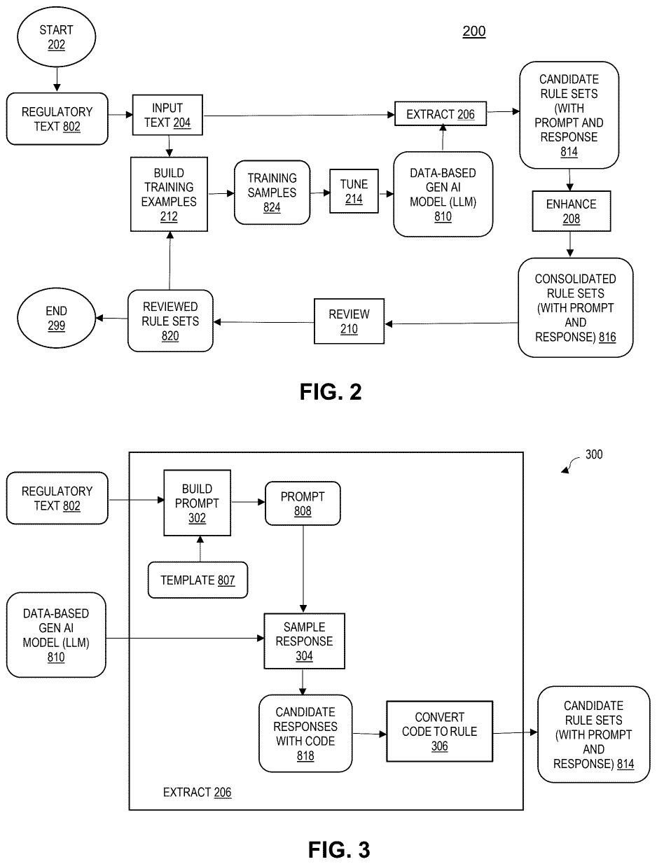

FIG. 2, which should be read in conjunction with FIGS. 3-8, depicts a high-level exemplary schematic flow diagram 200 depicting operation methods steps for enhancing responses, according to an embodiment of the present invention.

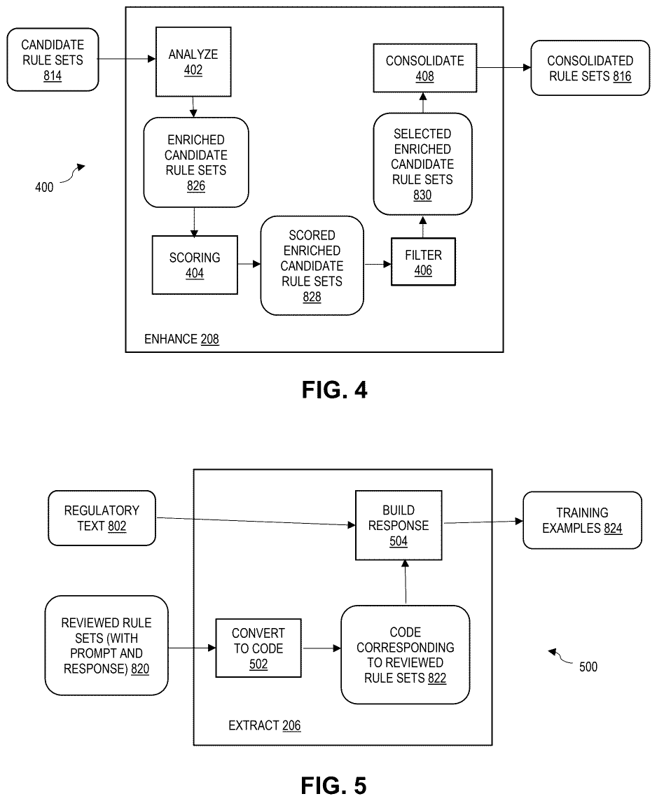

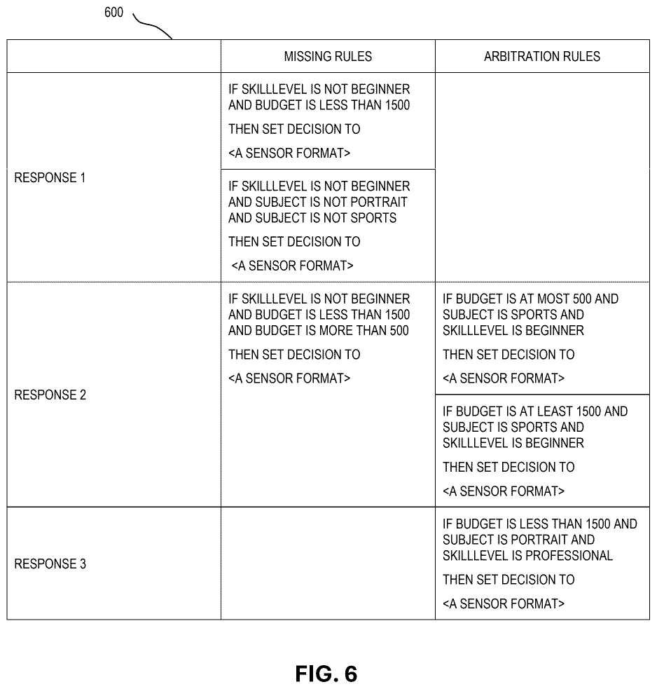

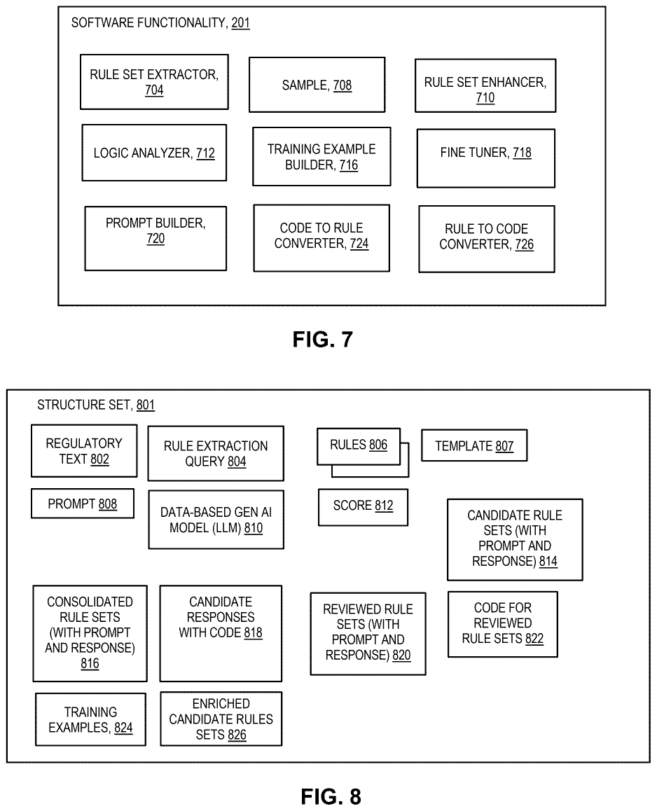

FIG. 3 depicts a detailed exemplary schematic flow diagram 300 depicting operation methods steps for rule set extraction, according to an embodiment of the present invention. FIG. 4 depicts a detailed exemplary schematic flow diagram 400 depicting operation methods steps for rule set enhancement, according to an embodiment of the present invention. FIG. 5 depicts a detailed exemplary schematic flow diagram 500 depicting operation methods steps for building training examples, according to an embodiment of the present invention. FIG. 6 depicts missing rules and arbitration rules 600 for the three LLM responses, according to an embodiment of the present invention. FIG. 7 depicts software components used in the computer-implemented method of FIG. 2, according to an embodiment of the present invention. FIG. 8 depicts structure set 801, having structures used in the method of FIG. 2, according to an embodiment of the present invention.

The computer-implemented method 200 starts at step 202.

At step 204 an input component 1250 inputs a specification. In an embodiment, the specification is a regulatory text 802. The skilled person would understand that other specifications could be used.

Rule set extraction. At step 206 a rule set extractor 704 uses received rule extraction queries 804 to extract several candidate rule sets 814 from the regulatory text 802. FIG. 3 depicts a detailed exemplary schematic flow diagram 300 depicting operation methods steps for rule set extraction, according to an embodiment of the present invention. The regulatory text 802 is passed to a rule set extractor 704 that uses an LLM fine-tuned for programming code generation. This LLM may be based on a pretrained transformer model, which is able to predict the next word in very large text corpus. The LLM may have been fine-tuned with the help of reinforcement learning, which results into a probabilistic policy. The rule set extractor 704 transforms the regulatory text 802 into candidate rule sets 814. It may use a data based generative AI model, such as an LLM combined with other techniques for this purpose. These techniques may have a probabilistic nature and employ search techniques in order to generate different results.

At step 302 the regulatory text 802 is passed to a prompt builder 720, which creates a prompt 808 suitable for rule set extraction, e.g. by using a predefined prompt template 807. At step 304 a sample component 708 collects candidate responses 818 from the LLM for this prompt 808. These candidate responses 818 consist of programming code, for example represented in a structured from such as JSON code. At step 306 a code to rule converter 724 transforms each of these programming codes into candidate rules sets 814.

For example, it may detect if-then-statements within a code and extract it in form of a rule. It also translates the programming code into the syntax of a rule language:
Code: if skill_level==SkillLevel.BEGINNER and budget >=1500: return SensorFormat.APS_C
Corresponding rule: if skillLevel is beginner and budget is at least 1500 then set decision to APS_C

The rule set extractor 704 will thus be able to generate multiple candidate rule sets 814. These candidate rule sets 814 are passed to a rule set enhancer 710. The computer-implemented method returns to step 208 of FIG. 2.

Rule set enhancement. FIG. 4 depicts a detailed exemplary schematic flow diagram 400 depicting operation methods steps for rule set enhancement, according to an embodiment of the present invention. At step 402, the rule set enhancer 710 analyzes each candidate rule set 814 for completeness, consistency, and compactness. The rule set enhancer 710 uses a logic analyzer 712, which also may be referred to as a logical rule analyzer, to consolidate each candidate rule set 814 by bringing it into a complete, consistent, and compact form to produce enriched candidate rule sets 826.

The rule set enhancer 710 enriches each candidate rule set with additional rules (for example, detected missing rules, arbitration rules, and generalized rules). The logic analyzer 712 is supplied with one or more candidate rule sets 814. The logic analyzer 712 analyzes each candidate rule set 814. This logic analyzer 712 performs different kinds of analyses and generates additional rules for each of these analyses. Due to the generative nature of the logic analyzer and the fact that it employs logic-based AI methods, it can be considered a form of generative AI that is based on logical reasoning methods instead of data-based methods. In some embodiments of the present invention, the logic analyzer 712 uses symbolic AI methods such as logical reasoning systems and constraint solvers to generate rules. The logic analyzer 712 guarantees that the additional rules are making the consolidated rule set consistent and complete. The following kinds of analysis are performed:

Completeness analysis: A rule set should make a unique decision for each case. The logic analyzer 712 detects cases to which no rule in the candidate rule set 814 is applicable and generates missing rules to cover those missing cases. These missing rules do not overlap with the rules in the candidate rule set 814. The logic analyzer 712 may generate missing rules of most-general form, i.e. there are no other missing rules that cover more cases than the generated missing rules. Conventional methods for computing missing rules for rule sets 814 construct a logical formula representing cases where no rule is applicable, employ a constraint solver or SMT solver to find a case that satisfies this formula, and generalize this case into a family of missing cases by determining a list of logical literals occurring in the formula that satisfy this case. These conventional methods further generalize this family by ordering the literals in decreasing generality and by determining a preferred minimal subset of literals that is sufficient to satisfy the logical formula. This last step is achieved by negating the logical formula, thus making it logically inconsistent with the list of logical literals, and by using methods such as QuickXplain for computing a preferred minimal inconsistent subset. The final step consists in combining the literals of this minimal subset into the condition of the missing rule.

Consistency analysis: Furthermore, the logic analyzer 712 detects cases to which multiple conflicting rules in the given rule set are applicable. The logic analyzer 712 generates arbitration rules that override the rules in the given rule set and that specify a unique decision for those problematic cases. The analyzer may generate arbitration rules of most-general form, i.e. there are no other arbitration rules that cover more cases than the generated missing rules. Conventional methods for computing arbitration rules for rule sets 814 build logical formulae that represent cases of interest, use a constraint solver to find those cases, and then use explanation-based generalization techniques, which minimize inconsistent subsets.

Compactness analysis: Finally, the logic analyzer 712 transforms the rules in the given rule set into rules with most-general conditions. These generalized rules are applicable to exactly the same cases as the original rules and are making exactly the same decisions for those cases. As they are in most-general form, there are no other rules that cover more cases than the generalized rules. The generalized rules constitute a more compact representation of the decision-making behavior of the rule set. Conventional methods for computing generalized rules build logical formulae that represent cases of interest, use a constraint solver to find those cases, and then use explanation-based generalization techniques.

At step 404, the rule set enhancer 710 also computes a score 812 for each of these enriched candidate rule sets 826 based on the analysis results by applying a given scoring function to the detected missing rules, arbitration rules (e.g. families of cases with conflicting decisions), and generalized rules to produce scored enriched candidate rule sets 828. The rule set enhancer 710 applies a given scoring function to each enriched candidate rule set 826 and computes a score 812 for the enriched candidate rule set 826. This scoring function illustrates certain improvements achieved by some embodiments of the present invention. For example, the scoring function may produce a higher score 812 for enriched candidate rule sets 826 with less missing rules. When applied to two enriched candidate rule sets 826 that have the same original rule set, the same arbitration rules, and the same generalized rules, the enriched candidate rule set 826 with less missing rules should receive a higher score 812. Furthermore, the scoring function may produce a higher score 812 for enriched candidate rule sets 826 with less arbitration rules. Those enriched candidate rule sets 826 will have fewer families of cases with conflicting decisions. The scoring function may also produce higher scores 812 for enriched candidate rule sets 826 with fewer generalized rules. The scoring function may also consider the size of the condition of the enriched candidate rule sets 826 (e.g. the number of conjuncts if the condition is a conjunction).

At step 406, the rule set enhancer 710 filters those scored enriched candidate rule sets 828 according to a selection rule (e.g. by using a threshold on the score 812 or by choosing the k best). Any of these selected enriched candidate rule sets 830 may be given as answer to the rule extraction query 804. For example, the selection rule may select those enriched candidate rule sets 830 that have a score 812 that exceeds a given threshold. Or the selection rule may select N enriched candidate rule sets 830 having the best scores 812.

The rule set enhancer 710 then uses a selection rule to select enriched candidate rule sets 830. For example, it may select those enriched candidate rule sets 830 that have a score 812 that exceeds a given threshold. Or the selection rule may select N enriched candidate rule sets 830 having the best scores 812.

At step 408, the rule set enhancer 710 transforms each of the selected enriched candidate rule sets 830 into a consolidated rule set 816. For this purpose, it replaces its rules by the generalized rules and adds the missing rules and arbitration rules. The consolidated rule set 816 simply consists of the arbitration rules, the generalized rules, and the missing rules. The original rules in the rule set are thus replaced by the generalized rules. If some original rules are already in most-general form, they have been regenerated as a generalized rule as part of the compactness analysis. It should also be noted that the arbitration rules have priority over the other rules. When deploying such a rule set, the first applicable rule should make the decision.

The output of step 208 is a consolidated rule set 816.

Review. Returning to FIG. 2, at step 210, the consolidated rule sets 816 may be reviewed. A domain expert may review the consolidated rule sets 816. The domain expert will choose the decision for the missing rules 806 and the arbitration rules 806 by using the regulatory text 802 and other information. The domain expert may also change the scoring function and selection function if the selection made by the rule set enhancer 710 is not fully satisfactory. Any of the reviewed consolidated rule sets 820 can be returned as an answer to the rule-extraction query. The human review is mainly needed to choose a decision for a missing rule or an arbitration rule. In another embodiment review could also be done by technical systems. For example, one might use a machine learning model that is trained with data sampled from the rules. Another idea is to call the LLM again with a prompt that asks which decision the given regulatory text 802 provides for cases under which the missing or arbitration rule is applicable. The output of step 210 is a reviewed rule set

At step 299, the computer-implemented method may either end, or continue to step 212.

Training. If the computer-implemented method continues, a feedback loop is provided. At step 212 training examples 824 are built.

A training example builder 716 produces enhanced responses for the given regulatory text 802 based on the reviewed rule sets 820. The training example builder 716 transforms each of the reviewed consolidated rule sets 820 back into the format needed to fine-tune the LLM 810 employed by the rule set extractor 704. If this LLM has been fine-tuned to directly produce rule sets 814, the reviewed consolidated rule sets 820 can be directly associated with the given regulatory text 802 in order to form a training example.

If the LLM has been fine-tuned to produce some intermediate format such as code snippets in form of if-then statements of some programming language, the reviewed rule sets 820 first need to be transformed into sets of if-then statements of this programming language. The training example builder 716 may also need the original response given by the LLM. For this purpose, the candidate rule sets 814 and reviewed consolidated rule sets 820 in FIG. 4 are provided to the LLM prompt and the prompt response (not depicted).

FIG. 5 depicts components of the training example builder 716 that produces training examples 824 for the LLM fine-tuned for programming code generation. The training example builder 716 is supplied with the reviewed rule sets 820 as well as the regulatory text 802 from the rule extraction query 804. At step 502 the training example builder 716 translates each review rule set 820 back into the syntax of the programming language using a rule to code converter 726. The rule to code converter 726 may also represent this code fragment in form of a JSON format. This results into code 822 corresponding to the each of the reviewed rule sets 820. At step 504 the training example builder 716 builds a full response of training examples 824 by combining the original prompt form the regulatory text 802.

Fine-tuning. Returning to FIG. 2, at step 214 a fine-tuner component 718 uses the training examples 824 to fine-tune. The training examples 824 are passed to the fine tuner component 718 of the employed LLM. Even if fine-tuning might be done in an online mode for each regulatory query, it will usually be done in offline mode after enough rule-extraction queries have been received. The result of the fine-tuning is a modified LLM, which can then be used to process future rule-extraction queries.

The system thus involves feed-back originating from a logic analyzer 712 as well as optional human feed-back.

Illustrative Example: Embodiments of the present invention consolidate extracted rule sets 814 by adding missing rules (for cases with missing decisions) and arbitration rules (for cases with conflicting decisions), among other transformations. Embodiments of the present invention use scores formulated in terms of the number of missing rules and arbitration rules to choose among different candidate rule sets 814. Embodiments of the present invention produce training examples based on the reviewed rule sets 820 for future fine-tuning. The following is a simple example from a well-known domain, namely choosing the sensor format for a mirrorless camera.

In this simple example, a regulatory text 802 prescribes a sensor format depending on several factors such as the level of the photographer (beginner vs professional), the available budget, and the main subject of photography (landscape, portrait, and sports). The regulatory text 802 has a structured form, and lists different cases, prescribing a sensor format that each should have:

TABLE 1
Example regulatory text

| | |
|---|---|
| 1. | APS-C for beginners and budgets of 1500 or more. |
| 2. | full frame for professionals, portraits, and budgets of 1500 or more. |
| 3. | full frame for professionals, sports, and budgets of 1500 or more. |
| 4. | Micro Four Thirds for landscapes and budgets of 500 or less. |
| 5. | APS-C for landscapes and budgets of 1500 or more. |
| 6. | Micro Four Thirds for portraits and budgets of 500 or less. |
| 7. | APS-C for budgets strictly between 500 and 1500. |
| 8. | No sensor format is available for sports and budgets of 500 or less. |

APS-C, and Micro Four Thirds, are image sensor formats. APS-C measure 22.2 × 14.8 mm for Canon cameras and approximately 23.6 × 15.7 mm for other brands like Nikon and Sony. Micro Four Thirds measure 17.3 × 13 mm.
This list of cases is complete and consistent.

The regulatory text 802 is passed to the rule set extractor 704, which first builds a prompt 808 for generating Python code, then sends this prompt 808 to an LLM 810, and finally converts this Python code into a candidate rule set 814. The prompt 808 should not only ask for Python code, but also give some indications about the form of this code. The following prompt template 807 provides those indications.

TABLE 2
Prompt template

Generate a simple pure Python code with flat conditions for the following cases. Use enumerated types for
<description of enumeration types>. And use conjunctions for the conditions.
<regulatory text>

This template contains two placeholders, namely one for the regulatory text 802 and another one giving a description of the enumeration type. The enumeration type requires additional information and may be provided as input together with the regulatory text 802. For example, enumeration type may have the following form:

TABLE 3
Enumeration type

the sensor format and the subject of photography consisting of landscape, portrait, and sports and for the skill
level consisting of beginner and professional.

The prompt builder 720 replaces the placeholders with the given texts and send the resulting prompt 808 to the LLM 810. In the example, three responses have been requested from the LLM 810. These are depicted in left hand panes of Tables 4, 5 and 6, respectively. None of these responses is fully correct, but they differ in their accuracy as discussed below. For example, the first response adds a condition about skill level to each of the generated rules although the regulatory text 802 expresses a condition about skill level in only three of the eight items.

TABLE 4
LLM response 1 (left) and conversion to rule set (right)

| | | |
|---|---|---|
| def choose_sensor_format(subject, skill_level, budget): | 1. | if skillLevel is beginner and budget is at least |
| if skill_level == SkillLevel.BEGINNER and budget >= | | 1500 then set decision to APS_C |
| 1500: return SensorFormat.APS_C | 2. | if skillLevel is professional and (subject is portrait |
| elif skill_level == SkillLevel.PROFESSIONAL: | | or subject is sports) and budget is at least 1500 |
| if subject == Subject.PORTRAIT or subject == | | then set decision to full frame |
| Subject.SPORTS: | 3. | if skillLevel is beginner and subject is landscape |
| if budget >= 1500: | | and budget is at most 500 then set decision to |
| return SensorFormat.FULL_FRAME | | micro four thirds |
| elif skill_level == SkillLevel.BEGINNER: | 4. | if skillLevel is beginner and subject is landscape |
| if subject == Subject.LANDSCAPE and budget <= 500: | | and budget is at least 1500 then set decision to |
| return SensorFormat.MICRO_FOUR_THIRDS | | APS_C |
| elif subject == Subject.LANDSCAPE and budget >= | 5. | if skillLevel is beginner and subject is portrait and |
| 1500: return SensorFormat.APS_C | | budget is at most 500 then set decision to micro |
| elif subject == Subject.PORTRAIT and budget <= 500: | | four thirds |
| return SensorFormat.MICRO_FOUR_THIRDS | 6. | if skillLevel is beginner and subject is sports and |
| elif subject == Subject.SPORTS and budget <= 500: | | budget is at most 500 then set decision to none |
| return None | 7. | if skillLevel is beginner and budget is more than |
| elif 500 < budget < 1500: | | 500 and budget is less than 1500 then set |
| return SensorFormat.APS_C | | decision to APS_C |
| elif skill_level == SkillLevel.PROFESSIONAL: | 8. | if skillLevel is professional and subject is portrait |
| if subject == Subject.PORTRAIT and budget >= | | and budget is at least 1500 then set decision to |
| 1500: | | full frame |
| return SensorFormat.FULL_FRAME | 9. | if skillLevel is professional and subject is sports |
| elif subject == Subject.SPORTS and budget >= | | and budget is at least 1500 then set decision to |
| 1500: | | full frame |
| return SensorFormat.FULL_FRAME | | |
| return None | | |

TABLE 5
LLM response 2 (left) and conversion to rule set (right)

| | |
|---|---|
| def select_sensor_format(subject, skill_level, budget): | 1. if skillLevel is beginner and budget is at least 1500 |
| if skill_level == SkillLevel.BEGINNER and budget | then set decision to APS_C |
| >= 1500: return SensorFormat.APS_C | 2. if skillLevel is professional and (subject is portrait or |
| elif skill_level == SkillLevel.PROFESSIONAL and | subject is sports) and budget is at least 1500 then set |
| (subject == Subject.PORTRAIT or subject == | decision to full frame |
| Subject.SPORTS) and budget >= 1500: | 3. if skillLevel is professional and subject is landscape |
| return SensorFormat.FULL_FRAME | and budget is at least 1500 then set decision to full |
| elif skill_level == SkillLevel.PROFESSIONAL and | frame |
| subject == Subject.LANDSCAPE and budget >= 1500: | 4. if skillLevel is beginner and budget is at most 500 |
| return SensorFormat.FULL_FRAME | then set decision to micro four thirds |
| elif skill_level == SkillLevel.BEGINNER and budget | 5. if subject is landscape and budget is at most 500 |
| <= 500: | then set decision to micro four thirds |
| return SensorFormat.MICRO_FOUR_THIRDS | 6. if skillLevel is beginner and budget is more than 500 |
| elif subject == Subject.LANDSCAPE and budget <= | and budget is less than 1500 then set decision to |
| 500: | APS_C |
| return SensorFormat.MICRO_FOUR_THIRDS | 7. if subject is portrait and budget is at most 500 then |
| elif skill_level == SkillLevel.BEGINNER and 500 < | set decision to micro four thirds |
| budget < 1500: | 8. if subject is sports and budget is at most 500 then |
| return SensorFormat.APS_C | set decision to none |
| elif subject == Subject.PORTRAIT and budget <= | 9. if subject is sports and budget is at least 1500 then |
| 500: | set decision to full frame |
| return SensorFormat.MICRO_FOUR_THIRDS | |
| elif subject == Subject.SPORTS and budget <= 500: | |
| return None | |
| elif subject == Subject.SPORTS and budget >= | |
| 1500: | |
| return SensorFormat.FULL_FRAME | |
| else: | |
| return None | |

TABLE 6
LLM response 3 (left) and conversion to rule set (right)

| | | |
|---|---|---|
| def select_sensor_format(subject, skill_level, budget): | 1. | if skillLevel is beginner and budget is at least |
| if skill_level == SkillLevel.BEGINNER and budget >= | | 1500 then set decision to APS_C |
| 1500: return SensorFormat.APS_C | 2. | if skillLevel is professional and (subject is portrait |
| elif skill_level == SkillLevel.PROFESSIONAL: | | or (subject is sports and budget is at least 1500)) |
| if subject == Subject.PORTRAIT or (subject == | | then set decision to full frame |
| Subject.SPORTS and budget >= 1500): | 3. | if subject is landscape and budget is at most 500 |
| return SensorFormat.FULL_FRAME | | then set decision to micro four thirds |
| elif subject == Subject.LANDSCAPE and budget <= | 4. | if subject is landscape and budget is at least 1500 |
| 500: | | then set decision to APS_C |
| return SensorFormat.MICRO_FOUR_THIRDS | 5. | if subject is portrait and budget is at most 500 |
| elif subject == Subject.LANDSCAPE and budget >= | | then set decision to micro four thirds |
| 1500: return SensorFormat.APS_C | 6. | if budget is more than 500 and budget is less than |
| elif subject == Subject.PORTRAIT and budget <= 500: | | 1500 then set decision to APS_C |
| return SensorFormat.MICRO_FOUR_THIRDS | 7. | if subject is sports and budget is at most 500 then |
| elif 500 < budget < 1500: | | set decision to none |
| return SensorFormat.APS_C | | |
| elif subject == Subject.SPORTS and budget <= 500: | | |
| return None | | |

The code to rule converter 724 converts the generated Python code into a rule language. This will not only modify the syntax, but also the semantics.

The Python code (in left hand columns of the above tables) comprises if-then-else statement, whereas the resulting rules (in right hand columns of the above tables) correspond to if-then statements. The code to rule converter 724 thus removes the else-branches and the nesting of the if-then statements. Conditions of nested if-then statements are complemented with the conditions of the surrounding if-then-else statements (or their negations). Whereas the Python code specifies a fixed order in which the if-then statements are applied, this ordering appears to be a quite arbitrary one and is therefore ignored in the resulting rule set. A regulatory text 802 should ensure that the order of its different statements does not matter or explicitly state which statement has precedence over which other statement. It might be difficult to reflect these statements about precedence in the extracted Python code, meaning that this order information needs to be extracted from the regulatory text 802 in a different form.

The code to rule converter 724 has the following functionality:
An else-branch that has no if-then-statement will be transformed into a default rule, which is applicable if no other rule is applicable.
The Python code contains if-then statements that involve disjunctions in their conditions. Rules involving disjunctions are more difficult to understand as it is not clear which of the disjuncts are satisfied when the rule is applicable. Therefore, the code to rule converter 724 may replace if-then statements with disjunctions by several rules, namely one for each disjunct.
The Python code is given in form of a function that has return statements. The code to rule converter 724 will transform return statements into assignment to a decision variable if those return statements provide a well-defined value.
The code to rule converter 724 will transform the Python syntax of conditions and expressions into a rule language. For example, the rule language may use verbalizations for comparison predicates. As such, “==” will be replaced by “is”, “>=” will be replaced by “is at least”, “>” will be replaced by “is more than”, “<=” will be replaced by “is at most”, and “<” will be replaced by “is less than”.
Moreover, values of an enumerated type (such as SkillLevel.BEGINNER) will be replaced by their textual representation (such as BEGINNER). Furthermore, the Python syntax for if-then statements is replaced by the corresponding syntax of the rule language.

The conversions of the three responses are shown on the right sides of Tables 4, 5 and 6.

The three candidate rule sets 814 are then passed to the logic analyzer 712, which determines cases with missing decisions and cases with conflicting decisions. It should be noted that default rules are ignored by this analysis. The generated missing rules and arbitration rules are shown in FIG. 6.

As the first response adds conditions about skill level to each rule, it is likely that it misses some cases. The logic analyzer 712 finds out that there is no recommendation of a sensor format for non-beginners (i.e. professionals) and budget less than 1500. Furthermore, there is no recommendation for non-beginners and subjects other than portrait and sports (e.g. for landscape).

The second response has several inaccuracies. Some of them are leading to missing rules and arbitration rules. For example, the regulatory text 802 recommends an APS-C sensor for intermediate budgets (i.e. regulatory text 802 #7), but in the generated rule set this recommendation is limited to beginners (see LLM response 2 #6):
if skillLevel is beginner and budget is more than 500 and budget is less than 1500 then set decision to APS_C.

For this reason, the logic analyzer 712 reports a missing rule for non-beginners and intermediate budgets.

Furthermore, the generated rule set contains some rules that do not correspond to any of the cases listed in the regulatory text 802.

In LLMs, a “hallucination” refers to the generation of false or misleading information presented as fact by an AI system. In the context of rules, these could arise due to:
Incorrect rule application: A rule is applied in a situation where it shouldn't be, leading to an incorrect or unexpected outcome.
Rule conflicts: When multiple rules contradict each other, the system might produce results that don't align with the intended logic.
Incomplete rule set: If the rule set doesn't cover all possible scenarios, the system might generate outputs that appear plausible but are actually incorrect or unsupported.
Overfitting: Rules that are too specific to the training data might produce incorrect results when applied to new, slightly different situations.
Cascading errors: An error in one rule could propagate through the system, causing a chain of incorrect inferences.

A first example of a “hallucinated” rule is LLM response 2 #4:
if skillLevel is beginner and budget is at most 500 then set decision to micro four thirds

This rule conflicts with LLM response 2 #5, and #7. The logic analyzer 712 detects this in form of a first arbitration rule.

Similarly, the following rule does not correspond to any case listed in the regulatory text 802:
if subject is sports and budget is at least 1500 then set decision to full frame

This rule conflicts with first rule if the skill level is beginner. The logic analyzer 712 detects this in form of a second arbitration rule.

There are also some inaccuracies in the second rule that cannot be detected by the logic analyzer 812. The regulatory text 802 recommends an APS-C sensor for landscape and high budgets. This recommendation is changed into full frame if the skill level is professional:
if skillLevel is professional and subject is landscape and budget is at least 1500 then set decision to full frame

This cannot be detected by the logic analyzer 812 since there is no other rule in the rule set that is applicable to this case and that provides the original recommendation.

LLM response 3 has a single problem, namely in its second rule where the budget condition is only required for sport photography, but not for portraits. This leads to a single missing rule. This last response has no further errors and is the most accurate one among the three responses.

Even if the logic analyzer 712 is not able to detect all inaccuracies, it is likely that hallucinations will introduce errors in form of cases with missing and conflicting decisions. In the example, better responses have less errors. If the number of missing rules and arbitration rules is correlated with the number of inaccuracies, some embodiments of the present invention may be able to select good candidate rule sets 814.

As the candidate rule sets 814 have now been analyzed, at step 404 the rule set enhancer 710 computes a score 812 for them. A single scoring rule consists in computing the negative total number of missing and arbitration rules. The first candidate rule set will thus receive a score 812 of −2, the second one a score 812 of −3, and the third one a score 812 of −1.

In the next step 406, the rule set enhancer 710 selects candidate rule sets 814 based on the score 812. For example, it may simply choose a candidate rule set with best score 812. This is the third rule set.

In the last step 408, the rule set enhancer 710 consolidates the selected rule set and adds the missing rules and arbitration rules. As arbitration rules have higher priority than the other rule, the rules in the consolidated rule set 816 have an associated priority. The third rule set of the example has a single arbitration rule and no missing rule.
if budget is less than 1500 and subject is portrait and skillLevel is professional then set decision to <a sensor format>

The consolidated rule set 816 is obtained by adding this arbitration rule to the generated rule set while indicating that this arbitration rule has a priority of one and the generated rules have a priority of zero. This consolidated rule set is shown in the left part of the following table. The consolidated rule set 816 is provided as a result by the rule set enhancer 710.

TABLE 7
Consolidated rule set (left) and conversion to rule set (right)

| | |
|---|---|
| Priority 1: | def select_sensor_format(subject, skill_level, budget): |
| if budget is less than 1500 and subject is portrait and | if budget < 1500 and subject == Subject.PORTRAIT |
| skillLevel is professional then set decision to <a sensor | and skill_level == SkillLevel.PROFESSIONAL: |
| format> | return <a sensor format> |
| Priority 0: | if skill_level == SkillLevel.BEGINNER and budget |
| if skillLevel is beginner and budget is at least 1500 then | >= 1500: |
| set decision to APS_C | return SensorFormat.APS_C |
| if skillLevel is professional and (subject is portrait or | elif skill_level == SkillLevel.PROFESSIONAL and |
| (subject is sports and budget is at least 1500)) then set | (subject == Subject.PORTRAIT or (subject == |
| decision to full frame | Subject.SPORTS and budget >= 1500)): |
| if subject is landscape and budget is at most 500 then | return SensorFormat.FULL_FRAME |
| set decision to micro four thirds | elif subject == Subject.LANDSCAPE and budget <= |
| if subject is landscape and budget is at least 1500 then | 500: |
| set decision to APS_C | return SensorFormat.MICRO_FOUR_THIRDS |
| if subject is portrait and budget is at most 500 then set | elif subject == Subject.LANDSCAPE and budget >= |
| decision to micro four thirds | 1500: |
| if budget is more than 500 and budget is less than 1500 | return SensorFormat.APS_C |
| then set decision to APS_C | elif subject == Subject.PORTRAIT and budget <= |
| if subject is sports and budget is at most 500 then set | 500: |
| decision to none | return SensorFormat.MICRO_FOUR_THIRDS |
| | elif 500 < budget < 1500: |
| | return SensorFormat.APS_C |
| | elif subject == Subject.SPORTS and budget <= 500: |
| | return None |

The consolidated rule set 816 is then reviewed. In the example, the human expert may either fill the placeholder in the missing rule or correct the inaccurate rule of the generated rule set. For example, the expert may investigate the case described by the arbitration rule and determine that a full-frame sensor is the correct recommendation. The placeholder is then filled to be “full-frame”. This produces the reviewed rule set 820 as in the following table.

TABLE 8
Reviewed rule set (left) and conversion to rule set (right)

| | |
|---|---|
| Priority 1: | def select_sensor_format(subject, skill_level, budget): |
| if budget is less than 1500 and subject is portrait and | if budget < 1500 and subject == Subject.PORTRAIT |
| skillLevel is professional then set decision to full frame | and skill_level == SkillLevel.PROFESSIONAL: |
| Priority 0: | return SensorFormat.FULL_FRAME |
| if skillLevel is beginner and budget is at least 1500 then | if skill_level == SkillLevel.BEGINNER and budget >= |
| set decision to APS_C | 1500: |
| if skillLevel is professional and (subject is portrait or | return SensorFormat.APS_C |
| (subject is sports and budget is at least 1500)) then set | elif skill_level == SkillLevel.PROFESSIONAL and |
| decision to full frame | (subject == Subject.PORTRAIT or (subject == |
| if subject is landscape and budget is at most 500 then | Subject.SPORTS and budget >= 1500)): |
| set decision to micro four thirds | return SensorFormat.FULL_FRAME |
| if subject is landscape and budget is at least 1500 then | elif subject == Subject.LANDSCAPE and budget <= |
| set decision to APS_C | 500: |
| if subject is portrait and budget is at most 500 then set | return SensorFormat.MICRO_FOUR_THIRDS |
| decision to micro four thirds | elif subject == Subject.LANDSCAPE and budget >= |
| if budget is more than 500 and budget is less than 1500 | 1500: |
| then set decision to APS_C | return SensorFormat.APS_C |
| if subject is sports and budget is at most 500 then set | elif subject == Subject.PORTRAIT and budget <= |
| decision to none | 500: |
| | return SensorFormat.MICRO_FOUR_THIRDS |
| | elif 500 < budget < 1500: |
| | return SensorFormat.APS_C |
| | elif subject == Subject.SPORTS and budget <= 500: |
| | return None |

Discovery of priority information. A remaining question is whether to extract priority information from the LLM 810 and to provide it in the training feed-back or whether to discover the priority information in the extracted rules and to omit it in the training feed-back. The priority information is considered as follows:

If several rules are conflicting, the logic analyzer 712 generates arbitration rules which override the conflicting rules. It may also happen that several arbitration rules are conflicting, meaning that the logic analyzer 712 generates an arbitration rule of higher priority which will make decisions. This will lead to a hierarchy of arbitration rule, with a priority indicating the hierarchical level.

When the generated arbitration rules with their priority are added to the rule set 806, the logic analyzer 712 will not generate them again when conducting a consistency analysis for this extended rule set as it knows that these arbitration rules belong to a higher priority level and thus override conflicting rules. However, if the generated arbitration rules are added to the rule set without any priority information, the logic analyzer 712 treats these arbitration rules as ordinary rules, which are not able to override conflicting rules again. It will therefore detect the conflicting rules again and generate the same arbitration rule again. For this reason, the information about priorities is communicated to the logical rule analyzer 712.

Regulatory texts 802 may state a priority implicitly or explicitly and there may be a way to extract the priorities of rules in addition to the rules themselves. However, this will make the overall system more brittle. Another method consists in detecting arbitration rules within a rule set automatically by using a heuristic. In a first step, this method computes all arbitration rules for a given rule set while ignoring any priority information. As all priority information is ignored, the method will also ignore arbitration rules that might have been added to the rule set before and therefore computes them again. In a second step, this method will compare the computed arbitration rules and the given rules. If one of the original rules covers exactly the same cases as a generated arbitration rule, then it will be classified as an arbitration rule. As this arbitration rule is already contained in the given rule set, it will not be reported as a new arbitration rule. As such, it will neither appear in the response to the user, nor in the training feed-back.

In the example, an arbitration rule has been passed as training feed-back to the LLM 810. After re-training, the rule set extractor 704 may include such an arbitration rule in its response when being asked to extract rules 806 from the same text again:
if the budget is less than 1500 and the subject is portrait and the skillLevel is professional, then set decision to APS-C

In addition, the LLM 810 may generate the conflicting rules that are overridden by this arbitration rule:
if skillLevel is professional and (subject is portrait or (subject is sports and budget is at least 1500)) then set decision to full frame.
if subject is portrait and budget is at most 500 then set decision to micro four thirds.
if budget is more than 500 and budget is less than 1500 then set decision to APS_C

If the logic analyzer 712 does not receive any priority information, it will generate an arbitration rule again:
if budget is less than 1500 and subject is portrait and skillLevel is professional then set decision to <a sensor format>

This arbitration rule will then be compared with the given rules 806 and the method detects that it covers exactly the same cases as one of the given rules. The priority of this given rule will be set to the arbitration rule and the arbitration rule will be discarded.

This method thus permits the discovery of arbitration rules within a rule set, meaning that the rule set extractor does not need to extract priority information.

Alternative embodiments. In an alternative embodiment, as part of the feedback loop, the code 822 corresponding to reviewed rule sets 820 are converted into text and applied to update the regulatory text 802.

In an alternative embodiment, alternative data based generative AI models could be used, for example Transformer-Based Models and Hybrid models.

In an alternative embodiment, the logic analyzer 712 uses a different LLM from that of the data-based generative AI 810.

Although some embodiments of the present invention have been described using LLMs to convert text to code, there are alternative AI technologies that can also perform the same function. For example: rule-based systems (e.g. syntax-directed translation, and template-based generation); statistical methods (e.g. Hidden Markov Models, Probabilistic Context-Free Grammars); neural network approaches (non-LLM) (e.g. sequence-to-sequence models, tree-based models), hybrid approaches (e.g. neural-symbolic systems); and domain specific systems. In alternative embodiments, these technologies can also be combined with LLMs.

In an alternative embodiment, generated missing rules and/or arbitration rules are associated with a hierarchy of priorities.

In an alternative embodiment, the reviewed rule set 820 is substantially the same as the consolidated rule sets 816, so that at step 212 training examples 824 are formed from the consolidated rule sets 816 and the regulatory text 802.

Some embodiments of the present invention provide a computer-implemented method, system, computer program product and computer program, wherein the logical rule analyzer uses symbolic AI methods. Some embodiments of the present invention provide a computer-implemented method, system, computer program product and computer program, wherein the AI model comprises a data based generative AI model. Some embodiments of the present invention provide a computer-implemented method, system, computer program product and computer program, wherein the data based generative AI comprises a large language model, LLM.

Some embodiments of the present invention provide a computer-implemented method, system, computer program product and computer program, wherein the text document is provided by a rule extraction query. Some embodiments of the present invention provide a computer-implemented method, system, computer program product and computer program, wherein the set of additional rules comprises at least one of a list, the list comprising: missing rules; conflicting rules; and generalized rules.

Some embodiments of the present invention disclose which kind of feedback is needed such that the LLM reduces the number of missing and conflicting cases. As some of this feedback is quite technical in nature, it might be generated by a suitable technical system. Embodiments of the present invention complement human feed-back in RLHF by system-generated feed-back for the task of rule set extraction.

Some embodiments of the present invention disclose a system and computer-implemented method for fine-tuning extractors with feedback from a logical rule analyzer (and review by a domain expert). The rule set extractor needs to be able to extract rules from regulatory texts. It should be possible to fine-tune the rule set extractor by giving corrected responses for a rule-extraction query. The rule set extractor may consist of a LLM that has been fine-tuned for extracting rules from regulatory texts. The rule set extractor may also consist of an LLM for program-code extraction and a component that extracts rules from this program code. It is supposed that the rule set extractor can be trained to generate complete, consistent, and compact rule sets, but that it has no mechanism that provides completeness, consistency, and compactness guarantees.

Some embodiments of the present invention address this technical difficulty by combining a rule set extractor and a logical rule analyzer. Given a set of rules, a logical rule analyzer is able to transform these rules into a most general form, to identify missing rules in order to make the rule set complete, and to identify arbitration rules to make the rule set consistent. A logical rule analyzer is able to give guarantees about completeness, consistency, and compactness by following basic principles, which are verifiable. The logical rule analyzer is applied to rule sets generated by the rule set extractor. It thus corrects these rule sets and brings them into an expected form. Consequently, the resulting rule sets are complete, consistent, and compact. Furthermore, this permits the construction of training examples for fine-tuning the rule set extractor. As a result, the likelihood that the rule set extractor generates complete, consistent, and compact rule sets is increased.

Another difficulty consists in the fact that the rule set extractor may generate different candidate rule sets for a given regulatory text. This may be due to a probabilistic nature of the extraction method, which permits sampling of several results. It may also be due to the usage of search methods by the extractor, which permits the exploration of multiple results. These candidate rule sets may differ in their quality. Some candidate rule sets may have a small number of missing rules and others may have a large number. Similarly, some candidate rule sets may have a small number of conflicting rules, whereas others may have a large number. Furthermore, some candidate rule sets may be compact and consist of a small number of rules of general form, whereas other candidate rule sets may be large in size and consist of very specialized rules. The quality of a rule set may be measured by some scoring function that aggregates the number of missing rules, conflicting rules, and generalized rules into a single score. Candidate rule sets with larger scores are often preferred. In order to compute such scores, a logical rule analysis need to be conducted.

Some embodiments of the present invention improve the quality of the extracted rule sets as they are guaranteed to be complete, consistent, and compact. Some embodiments of the present invention reduce the time spent by the domain experts to validate rule sets generated by a rule set extractor as these rule sets are in a consolidated form and thus require less corrections. By generating missing rules and arbitration rules with well-crafted conditions, the domain expert can focus on choosing the decisions made by these rules. Some embodiments of the present invention detect certain form of “hallucinations” produced by the LLM. If the LLM produces rules that are not present in the regulatory text 802, they risk being in conflict with respect to other rules, which will thus be detected by the logical analyzer.

Some embodiments of the present invention improve the output of the rule set extractor for future queries and thus speed-up the analysis of this output by providing high-quality training examples.

Compared to systems for reinforcement learning with human feed-back (RLHF), some embodiments of the present invention complement human feed-back by results from a formal model implemented by the logical rule analyzer. Not only the training examples are generated by a technical system, but this technical system also provides guarantees about the properties of these training examples.

Some embodiments of the present invention circumvent the missing fine-tuning of LLMs for rule extraction by extracting program code as an intermediate step. Some embodiments of the present invention potentially detect certain forms of “hallucinations” produced by the LLM as “hallucinated rules” risk to be in conflict with respect to other rules and will thus be detected by the logical analyzer. Some embodiments of the present invention improve the quality of the extracted rule sets and guarantees that the consolidated rule sets are consistent and complete. Some embodiments of the present invention reduce the time spent by domain experts to validate rule sets generated by a rule set extractor as these consolidated rule sets require less corrections. Some embodiments of the present invention improve the output of the rule set extractor for future queries and thus speeds up the analysis of this output by providing high-quality training examples.

Knowledge acquisition has been a major bottleneck for developing rule-based expert systems and it is still a major bottleneck in modern decision management systems. Providing tools that facilitate the extraction of well-defined rule sets from regulatory texts is helpful to customers.

An example of use of an embodiment of the present invention is in a production line. Aspects of the present invention are applied to a specification of a product line to produce a set of encoded rules. The production line is then operated to these encoded rules.

1. A computer implemented method comprising:
extracting, using an artificial intelligence (AI) model, a set of candidate rule sets from a text document;
for individual rule sets of the candidate rule sets:
analyzing, using a logical rule analyzer, an individual rule set;
identifying a set of additional rules; and
enriching the individual rule set with the set of additional rules to determine an enriched candidate rule set corresponding to the individual rule set;
prioritizing a set of enriched candidate rule sets of the set of candidate rule sets; and
based on the prioritizing, filtering the set of enriched candidate rule sets to determine a set of consolidated rule sets.

2. The computer implemented method of claim 1, further comprising:
reviewing the set of consolidated rule sets to refine the set of consolidated rule sets with updates to the additional rules to determine a reviewed set of rule sets.

3. The computer implemented method claim 1, further comprising:
building a training example from the set of consolidated rule sets and the text document; and
based on the training example, fine-tuning the AI model to determine enhanced responses for the text document.

4. The computer implemented method of claim 1, wherein the text document is a regulatory text.

5. The computer implemented method of claim 1, wherein the logical rule analyzer uses symbolic AI methods.

6. The computer implemented method of claim 1, wherein the AI model comprises a data based generative AI model.

7. The computer implemented method of claim 6, wherein the data based generative AI comprises a large language model, LLM.

8. The computer implemented method of claim 1, wherein the text document is provided by a rule extraction query.

9. The computer implemented method of claim 1, wherein the the set of additional rules comprises at least one of a list, the list comprising: missing rules; conflicting rules; and generalized rules.

10. A computer system comprising:
a processor set;
computer-readable storage media; and
program instructions stored on the computer-readable storage media to cause the processor set to perform operations comprising:
extracting, using an artificial intelligence (AI) model, a set of candidate rule sets from a text document;
for individual rule sets of the candidate rule sets:
analyzing, using a logical rule analyzer, an individual rule set;
identifying a set of additional rules; and
enriching the individual rule set with the set of additional rules to determine an enriched candidate rule set corresponding to the individual rule set;
prioritizing a set of enriched candidate rule sets of the set of candidate rule sets; and
based on the prioritizing, filtering the set of enriched candidate rule sets to determine a set of consolidated rule sets.

11. The computer system of claim 10, wherein the operations further comprise:
reviewing the set of consolidated rule sets to refine the set of consolidated rule sets with updates to the additional rules to determine a reviewed set of rule sets.

12. The computer system of claim 10, wherein the operations further comprise:
a training example builder for building a training example from the set of consolidated rule sets and the text document; and
based on the training example, a fine tuner component for fine-tuning the AI model to determine enhanced responses for the text document.

13. The computer system of claim 10, wherein the text document is a regulatory text.

14. The computer system of claim 10, wherein the logical rule analyzer uses symbolic AI methods.

15. The computer system of claim 10, wherein the AI model comprises a data based generative AI model.

16. The computer system of claim 10, wherein the text document is provided by a rule extraction query.

17. The computer system of claim 10, wherein the set of additional rules comprises at least one of a list, the list comprising: missing rules; conflicting rules; and generalized rules.

18. A computer program product comprising:
one or more computer-readable storage media; and
program instructions stored on the one or more computer-readable storage media to perform operations comprising:
extracting, using an artificial intelligence (AI) model, a set of candidate rule sets from a text document;
for individual rule sets of the candidate rule sets:
analyzing, using a logical rule analyzer, an individual rule set;
identifying a set of additional rules; and
enriching the individual rule set with the set of additional rules to determine an enriched candidate rule set corresponding to the individual rule set;
prioritizing a set of enriched candidate rule sets of the set of candidate rule sets; and
based on the prioritizing, filtering the set of enriched candidate rule sets to determine a set of consolidated rule sets.

19. The computer program product of claim 18, wherein the operations further comprise:
reviewing the set of consolidated rule sets to refine the set of consolidated rule sets with updates to the additional rules to determine a reviewed set of rule sets.

20. The computer program product of claim 18, wherein the operations further comprise:
building a training example from the set of consolidated rule sets and the text document; and
based on the training example, fine-tuning the AI model to determine enhanced responses for the text document.
